(19) United States
(12) Patent Application Publication
(10) Pub. No.: US 2016/0256874 A1
(43) Pub. Date: Sep. 8, 2016

(54) METHOD OF FRAGMENTING AND/OR WEAKENING A MATERIAL BY MEANS OF HIGH VOLTAGE DISCHARGES

(71) Applicant: SELFRAG AG, Kerzers (CH)

(72) Inventors: Harald Giese, Stutensee (DE); Frédéric Von Der Weid, Genolier (CH); Helena Ahlqvist Jean-neret, Bollion (CH); Klaas Peter Van Der Wielen, Bern (CH); Reinhard Müller-siebert, Bern (CH); Alexander Weh, Bern (CH)

(21) Appl. No.: 15/031,346

(22) PCT Filed: Oct. 25, 2013
(86) PCT No.: PCT/CH2013/000184

§ 371 Date: Apr. 22, 2016

(51) Int. Cl. B02C 19/18; B02C 25/00

(52) U.S. Cl. CPC B02C 19/18; B02C 25/00; B02C 2019/183

(57) ABSTRACT

A method of fragmenting a material by means of high voltage discharges includes feeding the material through a process zone arranged between two electrodes flooded with a process liquid. High voltage discharges are generated between the electrodes and process liquid is fed into and discharged from the process zone. In that state, a degree of turbidity of the process liquid discharged is determined and compared with a reference value. In case a deviation from the reference value is detected, one or more parameters of the generation of high voltage discharges and/or of the feeding of the material through the process zone are changed such that, when after the changing of the parameters the determination of the degree of turbidity and the comparing with the reference value is repeated, the deviation which is detected is reduced or no deviation is detected.

### TECHNICAL FIELD

The invention concerns methods of fragmenting and/or weakening a material, in particular rock or ore, by means of high voltage discharges as well as arrangements for conducting these methods according to the preambles of the independent claims.

### BACKGROUND ART

It is known from prior art to treat material, like e.g. concrete or rock, by pulsed high voltage discharges in order to perform fragmentation and/or weakening of the material, i.e. to reduce the particle size of the material and/or to generate cracks within the material which facilitate fragmentation in a subsequent mechanical fragmentation process.

However, in order to make it possible to employ this technology in industrial scale production, it is crucial that a constant quality of the fragmented/weakened material can be ensured, which in particular is an unsolved problem in mineral processing applications, in which the material to be processed is a natural product which can vary in its physical properties to a large extend.

### DISCLOSURE OF THE INVENTION

Hence, it is a general object of the invention to provide methods of fragmenting and/or weakening material by means of high voltage discharges and arrangements for conducting these methods, which ensure a substantially constant quality of the processed material even when the feed material varies in quality, or which at least diminish the effect of the variation of the feed material on the quality of the processed material.

This object is achieved by the methods and arrangements according to the independent claims.

Accordingly, a first aspect of the invention concerns a method of fragmenting and/or weakening a material, for example rock or ore, by means of high voltage discharges. According to this method, the material that is to be fragmented and/or weakened is fed through a process zone which is formed between at least two electrodes arranged at a distance relative to each other and which is flooded with a process liquid. While feeding the material that is to be fragmented and/or weakened through the process zone, high voltage discharges are generated between the at least two electrodes, for fragmenting and/or weakening the material, and process liquid is fed into the process zone and is discharged from the process zone.

In that operational state, the degree of turbidity of the process liquid in the process zone or near the process zone or of the process liquid discharged from the process zone is determined, and/or, additionally or alternatively, a difference in the degrees of turbidity of the process liquid fed into the process zone and of the process liquid discharged from the process zone is determined. The determined degree of turbidity and/or, additionally or alternatively, the determined difference in the degrees of turbidity is or are compared with reference values for the degree of turbidity and/or for the difference in the degrees of turbidity, respectively.

In case a deviation of the determined degree of turbidity from the reference value for the degree of turbidity and/or of the determined difference in the degrees of turbidity from the reference value for the difference in the degrees of turbidity is detected, one or more parameters of the generation of high voltage discharges and/or of the feeding of the material through the process zone are changed in such a manner that, when after the changing of these parameters the determination of the degree of turbidity and/or of the difference in the degrees of turbidity and the comparison with the reference values is repeated, the deviation which is detected then is reduced or no deviation is detected.

In other words, by changing of the parameters of the generation of high voltage discharges and/or of the feeding of the material, the degree of turbidity of the process liquid in the process zone or near the process zone or of the process liquid discharged from the process zone and/or the difference in the degrees of turbidity of the process liquid fed into the process zone and of the process liquid discharged from the process zone is brought closer to a target value defined by the reference value it is compared with.

In a preferred embodiment of the method, a pre-determined reference value is used which is pre-determined in three steps. In the first step, the generating of high voltage discharges between the at least two electrodes and the feeding of the material that is to be fragmented and/or weakened through the process zone is adjusted in such a manner that the fragmented and/or weakened material leaving the process zone has a desired degree of fragmentation and/or weakening, respectively. In the second step, the degree of turbidity or the difference in the degrees of turbidity is determined in the operational state achieved by the first step. In the third step, the degree of turbidity and/or the difference in the degrees of turbidity determined in the second step is used as reference value. By doing so it becomes possible to optimize the fragmenting and/or weakening process for a specific material by experience and/or in an aleatory manner, e.g. by trial and error, and after a desired operational state has been found, to systematically run the process in that state, even under varying properties of the material that is fed into the process zone.

In a further preferred embodiment of the method, the determining of the degree of turbidity and/or of the difference in the degrees of turbidity, the comparing thereof with the reference value and, in case a deviation is detected, the changing of the generation of high voltage discharges and/or of the feeding of the material through the process zone is performed continuously, preferably in an automated manner. By doing so, in the intended operation, the degree of turbidity and/or the difference in the degrees of turbidity is kept on a level which substantially corresponds to the reference value or falls within a certain scatter around the reference value. Thus, the fragmenting and/or weakening process can be kept in a desired operational state represented by the reference value.

In still a further preferred embodiment of the method, the process liquid which is fed into the process zone has no turbidity or has a substantially constant degree of turbidity. This facilitates the control of the process.

A second aspect of the invention concerns a method of fragmenting and/or weakening a material, for example rock or ore, by means of high voltage discharges. According to this method, the material that is to be fragmented and/or weakened is fed through a process zone which is formed between at least two electrodes arranged at a distance relative to each other and which is flooded with a process liquid. While feeding the material that is to be fragmented and/or weakened through the process zone, high voltage discharges are generated between the at least two electrodes, for fragmenting and/or weakening the material, and process liquid is fed into the process zone and is discharged from the process zone.

In that state, the electrical resistance between at least two of the at least two electrodes, between at least one of the at least two electrodes and at least one auxiliary electrode or between at least two auxiliary electrodes just before the high voltage discharges occur is determined. The determined electrical resistance is compared with a reference value for the electrical resistance.

In case a deviation of the determined electrical resistance from the reference value for the electrical resistance is detected, one or more parameters of the feeding of material through the process zone, of the generating of high voltage discharges between the at least two electrodes, of the distance between the at least two electrodes and/or of the feeding and discharging of process liquid into the process zone and from the process zone are changed in such a manner that, when after the changing of the parameters the determination of the electrical resistance between the at least two of the at least two electrodes, between the at least one of the at least two electrodes and the at least one auxiliary electrode or between the at least two auxiliary electrodes just before the high voltage discharges occur and the comparing with the reference value is repeated, the deviation which is detected then is reduced or no deviation is detected.

In other words, by changing the parameters of the feeding of material through the process zone, of the generating of high voltage discharges between the at least two electrodes, of the distance between the at least two electrodes and/or of the feeding and discharging of process liquid into the process zone and from the process zone, the electrical resistance between the at least two of the at least two electrodes, between the at least one of the at least two electrodes and the at least one auxiliary electrode or between the at least two auxiliary electrodes just before the high voltage discharges occur is brought closer to a target value defined by the reference value it is compared with.

In a preferred embodiment of the method according to the second aspect of the invention, for determining the electrical resistance before the high voltage discharges occur, in a first step the maximum voltage between the electrodes, the voltage between the electrodes at the start of the discharge and the delay time between the maximum voltage and the voltage at the start of the discharge are determined. The term “the electrodes” for this embodiment means the at least two electrodes, between which the high voltage discharges occur. In a second step, with the known capacitance of the high voltage generator charging the electrodes, the electrical resistance between the electrodes before the high voltage discharges occur is computed according to or with involvement of the following formula:

$$R = \frac{t}{C} \cdot \frac{1}{ln ( \frac{{U}_{( ds )}}{{U}_{o}} )}$$

In this formula R is the electrical resistance between the electrodes before the high voltage discharges occur, U₀ is the maximum voltage between the electrodes, U_{(ds)} is the voltage between the electrodes at the start of the discharge, t is the delay time between the maximum voltage U₀ and the voltage U_{(ds)} at the start of the discharge and C is the known capacitance of the high voltage generator. Determining the electrical resistance between the electrodes before the high voltage discharges occur in this way has proven especially practical. The term “ln” means natural logarithm.

In a further preferred embodiment of this method, a pre-determined reference value is used which is pre-determined in three steps. In the first step, the generating of high voltage discharges between the at least two electrodes, the feeding of the material that is to be fragmented and/or weakened through the process zone, the distance between the electrodes and the feeding and discharging of process liquid is adjusted in such a manner that the fragmented and/or weakened material leaving the process zone has a desired degree of fragmentation or weakening, respectively. In the second step, the resistance between the electrodes before the high voltage discharges occur is determined in the operational state achieved by the first step. In the third step, the resistance between the electrodes before the high voltage discharges occur which has been determined in the second step is used as reference value. By doing so, it becomes possible to optimize the fragmenting and/or weakening process for a specific material by experience and/or in an aleatory manner, e.g. by trial and error, and after a desired operational state has been found, to systematically run the process in that state, even under varying properties of the material that is fed into the process zone.

In still a further preferred embodiment of the method, the determining of the electrical resistance between the electrodes, the comparing of the determined electrical resistance with a reference value and, in case a deviation is detected, the changing of the feeding of material through the process zone, of the generating of high voltage discharges between the electrodes, of the distance between the at least two electrodes and/or of the feeding and discharging of process liquid into the process zone and from the process zone is performed continuously, preferably in an automated manner. By doing so, in the intended operation, the electrical resistance between the electrodes before the high voltage discharges occur is kept on a level which substantially corresponds to the reference value or falls within a certain scatter around the reference value. Thus, the fragmenting and/or weakening process can be kept in a desired operational state represented by the reference value.

A third aspect of the invention concerns a method of fragmenting and/or weakening a material, for example rock or ore, by means of high voltage discharges. According to this method, the material that is to be fragmented and/or weakened is fed through a process zone which is formed between at least two electrodes arranged at a distance relative to each other and which is flooded with a process liquid. While feeding the material that is to be fragmented and/or weakened through the process zone, high voltage discharges are generated between the at least two electrodes, for fragmenting and/or weakening the material.

In that operational state, data representing an image of the fragmented and/or weakened material that is discharged from the process zone are determined, and/or, additionally or alternatively, data representing an image of the material that is fed to the process zone and data representing an image of the fragmented and/or weakened material that is discharged from the process zone and subsequently the degree of fragmentation and/or weakening of the material which is discharged from the process zone is determined by comparing the determined data representing the image of the material that is fed to the process zone with the determined data representing the image of the fragmented and/or weakened material that is discharged from the process zone.

The determined data representing the image of the fragmented and/or weakened material are compared with reference data for the image of fragmented and/or weakened material, and/or, additionally or alternatively, the determined degree of fragmentation and/or weakening of the material is compared with a reference value for the degree of fragmentation and/or weakening of the material.

In case a deviation of the determined data representing the image of the fragmented and/or weakened material from the reference data for the image of fragmented and/or weakened material and/or of the determined degree of fragmentation and/or weakening of the material from the reference value for the degree of fragmentation and/or weakening of the material is detected, one or more parameters of the generation of high voltage discharges and/or of the feeding of the material through the process zone are changed in such a manner that, when after the changing of the parameters the determination of the data representing the image of the fragmented and/or weakened material and/or of the degree of fragmentation and/or weakening of the material and the comparison with the reference data and/or the reference value is repeated, the deviation which is detected then is reduced or no deviation is detected.

In other words, by changing of the parameters of the generation of high voltage discharges and/or of the feeding of the material through the process zone, physical properties like e.g. size distribution or visual appearance, respectively, of the fragmented and/or weakened material that is discharged from the process zone and/or the degree of fragmentation and/or weakening the material is experiencing by being processed in the process zone is brought closer to a target state or value defined by the reference data and/or reference value.

In a preferred embodiment of the method, process liquid is fed into the process zone and process liquid is discharged from the process zone while feeding the material that is to be fragmented and/or weakened through the process zone and while generating high voltage discharges between the at least two electrodes. By doing so, a continuous operation with stable operation conditions can be achieved.

Preferably, the data representing the image or images, respectively, are determined by using digital cameras, preferably by using digital X-ray cameras. Data furnished by such cameras can easily be processed for comparison with each other or with reference data and image data furnished by X-Ray cameras can also contain information with respect to micro cracks in the material, thus with respect to the weakening of the material.

In a preferred embodiment of the method, pre-determined reference data representing the image of the fragmented and/or weakened material are used which are pre-determined in three steps. In the first step, the generating of high voltage discharges between the at least two electrodes and the feeding of the material that is to be fragmented and/or weakened through the process zone is adjusted in such a manner that the fragmented and/or weakened material leaving the process zone has a desired degree of fragmentation or weakening, respectively. In the second step, data representing an image of this material are determined in the operational state achieved by the first step. In the third step, the data representing an image of the fragmented and/or weakened material leaving the process zone which have been determined in the second step are used as reference data. By doing so, it becomes possible to optimize the fragmenting and/or weakening process for a specific material by experience and/or in an aleatory manner, e.g. by trial and error, and after a desired operational state has been found, to systematically run the process in that state, even under varying properties of the material that is fed into the process zone.

In a further preferred embodiment of the method, the determining of the data representing the image of the fragmented and/or weakened material, the comparing of the determined data representing the image with reference data, and, in case a deviation is detected, the changing of the generation of high voltage discharges and/or of the feeding of the material through the process zone is performed continuously, preferably in an automated manner.

By doing so, in the intended operation, physical properties like e.g. size distribution or visual appearance, respectively, of the fragmented and/or weakened material that is discharged from the process zone is kept on a level which substantially corresponds to the reference data or falls within a certain scatter around the reference data. Thus, the fragmenting and/or weakening process can be kept in a desired operational state represented by the reference data.

In still a further preferred embodiment of the method, a pre-determined reference value representing the degree of fragmentation and/or weakening of the material is used which is pre-determined in three steps. In the first step, the generating of high voltage discharges between the at least two electrodes and the feeding of the material that is to be fragmented and/or weakened through the process zone is adjusted in such a manner that the fragmented and/or weakened material leaving the process zone has a desired degree of fragmentation and/or weakening, respectively. In the second step, data representing an image of the material that is fed to the process zone and data representing an image of the fragmented and/or weakened material that is discharged from the process zone are determined in the operational state achieved by the first step, and a degree of fragmentation and/or weakening of the material is determined by comparing this determined data representing the image of the material that is fed to the process zone with the determined data representing the image of the fragmented and/or weakened material that is discharged from the process zone. In the third step, this determined degree of fragmentation and/or weakening of the material is used as reference value. By doing so, it becomes possible to optimize the fragmenting and/or weakening process for a specific material by experience and/or in an aleatory manner, e.g. by trial and error, and after a desired operational state has been found, to systematically run the process in that state, even under varying properties of the material that is fed into the process zone.

In still a further preferred embodiment of the method, the determining of the data representing the images of the material fed to and discharged from the process zone, the determining of the degree of fragmentation and/or weakening of the material, the comparing of the determined degree of fragmentation and/or weakening with the reference value, and, in case a deviation is detected, the changing of the generation of high voltage discharges and/or of the feeding of the material through the process zone is performed continuously, preferably in an automated manner.

By doing so, in the intended operation, the weakening the material is experiencing by being processed in the process zone is kept on a level which substantially corresponds to the reference value or falls within a certain scatter around the reference value. Thus, the fragmenting and/or weakening process can be kept in a desired operational state represented by the reference value.

In a further preferred embodiment of the before described methods according to the first, second or third aspect of the invention, the changing of the generation of high voltage discharges is accomplished in that the amount of fragmenting or weakening energy which is brought into the process zone by the high voltage discharges is changed. This is done preferably by changing the frequency of the high voltage discharges, the voltage of the high voltage discharges, the form of the pulses which drive the high voltage discharges, the energy stored per pulse in the generator which charges the at least two electrodes, the polarity of the at least two electrodes and/or the electrode gap of the at least two electrodes. Depending on the process equipment employed for conducting the method, one of these element alone or a combination thereof might be especially preferable.

In still a further preferred embodiment of the methods according to the first, second or third aspect of the invention, the changing of the feeding of the material through the process zone takes place by changing the residence time of the material in the process zone or by changing the ratio between the amount of material and the amount of process liquid which is present in the process zone. In the first case, the number of discharges the material travelling through the process zone is exposed to is changed, while in the second case, the amount of material which is exposed to each discharge is changed.

In still a further preferred embodiment of the methods according to the first, second or third aspect of the invention, the changing of the feeding and discharging of process liquid into the process zone and from the process zone is accomplished in that the amount, e.g. the volumetric flow rate, of process liquid that is fed into the process zone and that is discharged from the process zone is changed. This is preferred because it can be done in a simple way and is easy to control. However, it is also envisaged to change the feeding and discharging of process liquid in a different manner, e.g. by changing the physical properties of the process liquid fed into the process zone or e.g. by changing the location, direction or speed at which the process liquid is fed into the process zone.

In still a further preferred embodiment of the methods according to the first, second or third aspect of the invention, the process liquid which is discharged from the process zone is subjected to a conditioning step, in which its degree of turbidity and/or its electrical conductivity is reduced, and then is completely or partly fed back into the process zone. By means of this, the amount of process liquid required for running the process can significantly be reduced.

In still a further preferred embodiment of the methods according to the first, second or third aspect of the invention, the process liquid fed into the process zone has a substantially constant electrical conductivity. This is preferred in order to achieve a good controllability of the process.

In still a further preferred embodiment of the methods according to the first, second or third aspect of the invention, the feeding and discharging of process liquid takes place uninterrupted or in intervals. In the first case the advantage is arrived at, that stable operating conditions can be achieved.

In still a further preferred embodiment of the methods according to the first, second or third aspect of the invention, water is used as process liquid. Water is inexpensive, incombustible and is well proven as process liquid in methods of fragmenting material by means of high voltage discharges.

In still a further preferred embodiment of the methods according to the first, second or third aspect of the invention, a process zone is provided in which the at least two electrodes, i.e. the electrodes between which the high voltage discharges are generated, are arranged one above the other and/or beside each other. These configurations have proven to be especially suitable.

In still a further preferred embodiment of the methods according to the first, second or third aspect of the invention, a noble metal ore or a semiprecious metal ore is used as material to be fragmented and/or weakened, in particular a copper ore, a copper/gold ore or a platinum ore. Using the methods for processing these materials is especially commercially interesting.

In still a further preferred embodiment of the methods according to the first, second or third aspect of the invention, antecedent to the method a fragmentation and/or weakening of the material that is fragmented and/or weakened takes place, preferably a fragmenting and/or weakening by means of high voltage discharges, preferably by performing the method according to the first, second or third aspect of the invention.

In still a further preferred embodiment of the methods according to the first, second or third aspect of the invention, subsequent to the method a fragmentation and/or weakening of the material that has been fragmented and/or weakened according to the method takes place, preferably a fragmenting and/or weakening by means of high voltage discharges, preferably by performing the method according to the first, second or third aspect of the invention, or a mechanical fragmentation. This is especially economical if the process according to the method is mainly focused on pre-weakening the material in order to reduce energy consumption in the subsequent fragmentation/weakening process and/or to increase throughput.

In still a further preferred embodiment of the methods according to the first, second or third aspect of the invention, at least one parameter of an upstream process preceding the method and/or of a downstream process succeeding the method is determined. Based on this determined parameter, the reference value or the reference data is or are changed. By doing so, the methods according to the first, second or third aspect of the invention can be integrated into a complex production process.

In that case it is preferred that the upstream process preceding the method and/or the downstream process succeeding the method is a process according to the first, second or third aspect of the invention, in which the material that is fed through the process zone and/or the material that is discharged from the process zone is fragmented and/or weakened.

If the at least one parameter is or comprises a parameter of an upstream process, it is preferred that this parameter is correlated to the properties of the material that is leaving the upstream process for being fed to the process zone in order to be fragmented and/or weakened, in particular correlated to the type, amount, hardness and/or particle size of the material leaving the upstream process.

Preferred parameters of such nature are the power consumption of an apparatus for treating the material in the upstream process, e.g. of a crusher or a mill, the particle size of the material leaving the upstream process, the consumption of chemical additives or reagents used in the upstream process, the concentration of certain substances in a process fluid of the upstream process, and/or the amount of material leaving the upstream process.

If the at least one parameter is or comprises a parameter of an downstream process, it is preferred that this parameter is correlated to the properties of the fragmented and/or weakened material that is discharged from the process zone and is received by the downstream process for further treatment, in particular correlated to the type, amount, grindability, hardness and/or particle size of the material.

Preferred parameters of such nature are the power consumption of an apparatus for treating the material in the downstream process, in particular of a mill or a crusher, the pressure of a ball mill cyclone used in the downstream process, the particle size of the material entering the downstream process, the amount of material entering the downstream process, the consumption of chemical additives or reagents used in the downstream process, the concentration of certain substances in a process fluid of the downstream process, a tailing grade or a recovery factor achieved in the downstream process and/or the amount of material leaving the downstream process.

A fourth aspect of the invention concerns an arrangement for conducting the method according to the first aspect of the invention. This arrangement comprises a process zone formed between at least two electrodes which are arranged at a distance relative to each other. In the intended operation of the arrangement, the process zone is flooded with a process liquid, e.g. water. The arrangement comprises several installations of specific function. It comprises first means for feeding the material that is to be fragmented and/or weakened in the intended operation of the arrangement through the process zone. Such means could for example be a conveyor and/or a vibrating chute. It comprises second means for generating high voltage discharges between the at least two electrodes in the intended operation while feeding the material that is to be fragmented and/or weakened through the process zone for fragmenting and/or weakening the material. Such means typically include a high voltage generator and dedicated connections to the electrodes. The arrangement comprises third means for feeding process liquid into the process zone and for discharging process liquid from the process zone in the intended operation of the arrangement while feeding the material that is to be fragmented and/or weakened through the process zone and while generating high voltage discharges between the at least two electrodes. Such means can for example comprise a process liquid cycle with circulating pump, filters and dedicated piping. The arrangement comprises fourth means for determining a degree of turbidity of the process liquid in the process zone or near the process zone or of the liquid discharged from the process zone or for determining a difference in the degrees of turbidity of the process liquid fed into the process zone and of the process liquid discharged from the process zone. Such means can for example comprise an optical system with an optical path that travels through the process liquid between a light emitter and a light receiver and which is in position to distinguish different intensities of the light received by the light receiver as different degrees of turbidity. The above mentioned first and second means are designed in such a manner that at least one parameter of the feeding of the material through the process zone and/or at least one parameter of the generating of the high voltage discharges can be changed. By this, the arrangement is suitable for being used in conducting the method according to the first aspect of the invention.

In a preferred embodiment, the arrangement comprises a control unit by means of which the determined degree of turbidity can be compared with a reference value for the degree of turbidity or the determined difference in the degrees of turbidity can be compared with a reference value for the difference in the degrees of turbidity, and, in case a deviation of the determined degree of turbidity from the reference value for the degree of turbidity and/or of the determined difference in the degrees of turbidity from the reference value for the difference in the degrees of turbidity is detected, one or more parameters of the generation of high voltage discharges between the at least two electrodes and/or of the feeding of the material through the process zone can be changed or are changed, respectively, by the control unit in such a manner that, when after the changing of the parameters the determination of the degree of turbidity and/or of the difference in the degrees of turbidity and the comparison with the reference value is repeated, the deviation which is detected then is reduced or no deviation is detected.

In other words, the control unit in this embodiment is adapted to control parameters of the generation of high voltage discharges and/or of the feeding of the material in order to bring the degree of turbidity of the process liquid in the process zone or near the process zone or of the process liquid discharged from the process zone and/or the difference in the degrees of turbidity of the process liquid fed into the process zone and of the process liquid discharged from the process zone closer to a target value defined by the reference value it is compared with.

Preferably, the control unit is designed in such a manner that the determining of the degree of turbidity and/or of the difference in the degrees of turbidity, the comparing thereof with the reference value and, in case a deviation is detected, the changing of the parameters of the generation of high voltage discharges and/or of the feeding of the material through the process zone is performed continuously, preferably in an automated manner. By doing so, the degree of turbidity and/or the difference in the degrees of turbidity can be controlled by the control unit in such a manner that it is kept on a level which substantially corresponds to the reference value or falls within a certain scatter around the reference value. Thus, the fragmenting and/or weakening process can be kept by the control unit in a desired operational state represented by the reference value.

Furthermore it is preferred that the control unit is adapted for comparing the determined degree of turbidity and/or the determined difference in the degrees of turbidity with a reference value, which has been pre-determined by it. For doing so, the control unit is adapted to allow the non-automated, e.g. manual, adjustment of parameters of the generating of high voltage discharges between the at least two electrodes and of the feeding of the material that is to be fragmented and/or weakened through the process zone to an operational state in which the fragmented and/or weakened material leaving the process zone has a desired degree of fragmentation or weakening, respectively. In this operational state, the control unit determines the degree of turbidity and/or the difference in the degrees of turbidity and subsequently uses this degree of turbidity and/or this difference in the degrees of turbidity in the further controlling of the process as the reference value. By doing so, it becomes possible to manually optimize the fragmenting and/or weakening process for a specific material, and after a desired operational state has been found, to have the process run in that state by the control unit, even under varying properties of the material that is fed into the process zone.

A fifth aspect of the invention concerns an arrangement for conducting the method according to the second aspect of the invention. This arrangement comprises a process zone formed between at least two electrodes which are arranged at a distance relative to each other. In the intended operation of the arrangement, the process zone is flooded with a process liquid, e.g. water. The arrangement comprises several installations of specific function. It comprises first means for feeding the material that is to be fragmented and/or weakened in the intended operation of the arrangement through the process zone. Such means could for example be a conveyor and/or a chute. It comprises second means for generating high voltage discharges between the at least two electrodes in the intended operation while feeding the material that is to be fragmented and/or weakened through the process zone for fragmenting and/or weakening the material. Such means typically include a high voltage generator and dedicated connections to the electrodes. The arrangement comprises third means for feeding process liquid into the process zone and for discharging process liquid from the process zone in the intended operation of the arrangement while feeding the material that is to be fragmented and/or weakened through the process zone and while generating high voltage discharges between the at least two electrodes. Such means can for example comprise a process liquid cycle with circulating pump, filters and dedicated piping. The arrangement comprises fourth means for determining the electrical resistance between at least two of the at least two electrodes, between at least one of the at least two electrodes and at least one auxiliary electrode or between at least two auxiliary electrodes before the high voltage discharges occur. Such means typically include computerized measuring equipment which determines electrical parameters of the discharge cycle like the voltage curve and the current curve and derive therefrom the electrical resistance at the point in time the discharges occur. The above mentioned first and third means are designed in such a manner that at least one parameter of the feeding of the material through the process zone and/or at least one parameter of the feeding and discharging of process liquid into the process zone and from the process zone can be changed. By this, the arrangement is suitable for being used in conducting the method according to the second aspect of the invention.

In a preferred embodiment, the arrangement further comprises means for adjusting the distance between the at least two electrodes. By this, the variation of a further process parameter becomes possible.

In a further preferred embodiment, the arrangement comprises a control unit by means of which the determined electrical resistance can be compared with a reference value for the electrical resistance and, in case a deviation of the determined electrical resistance from the reference value is detected, one or more parameters of the feeding of material through the process zone, of the generating of high voltage discharges between the at least two electrodes, of the distance between the at least two electrodes and/or of the feeding and discharging of process liquid into the process zone and from the process zone can be changed or are changed, respectively, by the control unit in such a manner that, when after the changing of the parameters the determination of the electrical resistance between the at least two of the at least two electrodes, between the at least one of the at least two electrodes and the at least one auxiliary electrode or between the at least two auxiliary electrodes just before the high voltage discharges occur and the comparing with the reference value is repeated, the deviation which is detected then is reduced or no deviation is detected.

In other words, the control unit in this embodiment is adapted to control parameters of the feeding of material through the process zone, of the generating of high voltage discharges between the at least two electrodes, of the distance between the at least two electrodes and/or of the feeding and discharging of process liquid into the process zone and from the process zone in order to bring the electrical resistance between the at least two of the at least two electrodes, between the at least one of the at least two electrodes and the at least one auxiliary electrode and/or between the at least two auxiliary electrodes before the high voltage discharges occur closer to a target value defined by the reference value it is compared with.

Preferably, the control unit is designed in such a manner that the determining of the electrical resistance, the comparing of the determined electrical resistance with the reference value and, in case a deviation is detected, the changing of the parameters of the of the feeding of material through the process zone, of the generating of the high voltage discharges between the electrodes, of the feeding and discharging of process liquid into the process zone and from the process zone and/or of the distance between the at least two electrodes is performed continuously, preferably in an automated manner. By doing so, the electrical resistance between the electrodes before the high voltage discharges occur can be controlled by the control unit in such a manner that it is kept on a level which substantially corresponds to the reference value or falls within a certain scatter around the reference value. Thus, the fragmenting and/or weakening process can be kept by the control unit in a desired operational state represented by the reference value.

Furthermore it is preferred that the control unit is adapted for comparing the determined electrical resistance with a reference value, which has been pre-determined by it. For doing so, the control unit is adapted to allow the non-automated, e.g. manual, adjustment of parameters of the generating of high voltage discharges between the at least two electrodes, of the feeding of the material that is to be fragmented and/or weakened through the process zone and of the feeding and discharging of process liquid to an operational state in which the fragmented and/or weakened material leaving the process zone has a desired degree of fragmentation or weakening, respectively. In this operational state, the control unit determines the electrical resistance between the electrodes before the high voltage discharges occur and subsequently uses this electrical resistance in the further controlling of the process as the reference value. By doing so, it becomes possible to manually optimize the fragmenting and/or weakening process for a specific material, and after a desired operational state has been found, to have the process run in that state by the control unit, even under varying properties of the material that is fed into the process zone.

A sixth aspect of the invention concerns an arrangement for conducting the method according to the third aspect of the invention. This arrangement comprises a process zone formed between at least two electrodes which are arranged at a distance relative to each other. In the intended operation of the arrangement, the process zone is flooded with a process liquid, e.g. water. The arrangement comprises several installations of specific function. It comprises first means for feeding the material that is to be fragmented and/or weakened in the intended operation of the arrangement through the process zone. Such means could for example be a conveyor and/or a chute. It comprises second means for generating high voltage discharges between the at least two electrodes in the intended operation while feeding the material that is to be fragmented and/or weakened through the process zone for fragmenting and/or weakening the material. Such means typically include a high voltage generator and dedicated connections to the electrodes. The arrangement comprises third means for determining data representing an image of the fragmented and/or weakened material that is discharged from the process zone or for determining data representing an image of the material that is fed to the process zone, for determining data representing an image of the fragmented and/or weakened material that is discharged from the process zone and for determining the degree of fragmentation and/or weakening of the material discharged from the process zone by comparing the determined data representing the image of the material that is fed to the process zone with the determined data representing the image of the fragmented and/or weakened material that is discharged from the process zone. Such means can for example comprise one or more digital camera systems with or without computerized equipment for processing the digital data furnished by the cameras. The above mentioned first and second means are designed in such a manner that at least one parameter of the feeding of the material through the process zone and/or at least one parameter of the generating of the high voltage discharges can be changed. By this, the arrangement is suitable for being used in conducting the method according to the third aspect of the invention.

In a preferred embodiment, the arrangement further comprises means for feeding process liquid into the process zone and for discharging process liquid from the process zone while feeding the material that is to be fragmented and/or weakened through the process zone and while generating high voltage discharges between the at least two electrodes. By this, a continuous operation with stable operation conditions can be achieved.

In a further preferred embodiment, the arrangement comprises a control unit by means of which the determined data representing the image of the fragmented and/or weakened material can be compared with reference data for the image of the fragmented and/or weakened material or by means of which the determined degree of fragmentation and/or weakening of the material can be compared with a reference value for the degree of fragmentation and/or weakening, and, in case a deviation of the determined data representing the image of the fragmented and/or weakened material from the reference data for the image of the fragmented and/or weakened material or of the determined degree of fragmentation and/or weakening of the material from the reference value for the degree of fragmentation and/or weakening is detected, one or more parameters of the generating of high voltage discharges between the at least two electrodes and/or of the feeding of the material that is to be fragmented and/or weakened through the process zone can be changed or are changed, respectively, by the control unit in such a manner that, when after the changing of the parameters the determination of the data representing the image of the fragmented and/or weakened material and/or the determination of the degree of fragmentation and/or weakening of the material and the comparison with the reference value is repeated, the deviation which is detected then is reduced or no deviation is detected.

In other words, the control unit in this embodiment is adapted to control parameters of the generating of high voltage discharges between the at least two electrodes and/or of the feeding of the material that is to be fragmented and/or weakened through the process zone in order to bring physical properties like e.g. size distribution or visual appearance, respectively, of the fragmented and/or weakened material that is discharged from the process zone and/or the degree of fragmentation and/or weakening the material is experiencing by being processed in the process zone closer to a target value defined by the reference data or reference value it is compared with.

In a preferred embodiment, the control unit is designed in such a manner that the determining of the data representing the image of the material, the comparing of the determined data representing the image with reference data, and, in case a deviation is detected, the changing of the parameters of the generating of the high voltage discharges and/or of the feeding of the material through the process zone is performed continuously, preferably in an automated manner. By doing so, the physical properties like e.g. size distribution or visual appearance, respectively, of the fragmented and/or weakened material that is discharged from the process zone can be controlled by the control unit in such a manner that it is kept on a level which substantially corresponds to the reference data or falls within a certain scatter around the reference data. Thus, the fragmenting and/or weakening process can be kept by the control unit in a desired operational state represented by the reference data.

Furthermore it is preferred that the control unit is adapted for comparing the determined data representing the image with reference data with reference data which have been pre-determined by it. For doing so, the control unit is adapted to allow the non-automated, e.g. manual, adjustment of parameters of the generating of high voltage discharges between the at least two electrodes and of the feeding of the material that is to be fragmented and/or weakened through the process zone to an operational state in which the fragmented and/or weakened material leaving the process zone has a desired degree of fragmentation or weakening, respectively. In this operational state, the control unit determines the data representing the image of the fragmented and/or weakened material and subsequently uses these data in the further controlling of the process as the reference data. By doing so, it becomes possible to manually optimize the fragmenting and/or weakening process for a specific material, and after a desired operational state has been found, to have the process run in that state by the control unit, even under varying properties of the material that is fed into the process zone.

In a further preferred embodiment, the control unit is designed in such a manner that the determining of the data representing the images of the material fed to and discharged from the process zone, the determining of the degree of fragmentation and/or weakening of the material from these data, the comparing of the determined degree of fragmentation and/or weakening of the material with the reference value, and, in case a deviation is detected, the changing of the parameters of the generating of the high voltage discharges and/or of the feeding of the material through the process zone is performed continuously, preferably in an automated manner. By doing so, the weakening the material is experiencing by being processed in the process zone can be controlled by the control unit in such a manner that it is kept on a level which substantially corresponds to the reference value or falls within a certain scatter around the reference value. Thus, the fragmenting and/or weakening process can be kept by the control unit in a desired operational state represented by the reference value.

Furthermore it is preferred that the control unit is adapted for comparing the determined degree of fragmentation and/or weakening of the material with a reference value for the degree of fragmentation and/or weakening which has been pre-determined by it. For doing so, the control unit is adapted to allow the non-automated, e.g. manual, adjustment of parameters of the generating of high voltage discharges between the at least two electrodes and of the feeding of the material that is to be fragmented and/or weakened through the process zone to an operational state in which the fragmented and/or weakened material leaving the process zone has a desired degree of fragmentation or weakening, respectively. In this operational state, the control unit determines the data representing the images of the material that is fed to and discharged from the process zone, determines therefrom the degree of fragmentation and/or weakening of the material and subsequently uses this degree of fragmentation and/or weakening of the material in the further controlling of the process as the reference value for the degree of fragmentation and/or weakening of the material. By doing so, it becomes possible to manually optimize the fragmenting and/or weakening process for a specific material, and after a desired operational state has been found, to have the process run in that state by the control unit, even under varying properties of the material that is fed into the process zone.

In a further preferred embodiment of the before described arrangements according to the fourth, fifth or sixth aspect of the invention, the means for generating the high voltage discharges between the at least two electrodes are designed in such a manner that for the changing of the generation of high voltage discharges, the amount of fragmenting or weakening energy which is brought into the process zone by the high voltage discharges can be changed, in particular by changing the frequency of the high voltage discharges, the voltage of the high voltage discharges, the form of the pulses which drive the high voltage discharges, the energy stored per pulse in the generator which charges the at least two electrodes, the polarity of the at least two electrodes and/or the electrode gap of the at least two electrodes. Depending on the process equipment employed for conducting the method, changing one of these parameters alone or in combination with other parameters thereof might be especially preferable.

In still a further preferred embodiment of the before described arrangements according to the fourth, fifth or sixth aspect of the invention, the means for feeding the material that is to be fragmented and/or weakened through the process zone are designed in such a manner that for changing the feeding of the material through the process zone, the residence time of the material in the process zone can be changed or the ratio between the amount of material and the amount of process liquid which is present in the process zone can be changed. In the first case, the number of discharges the material travelling through the process zone is exposed to can be changed, while in the second case, the amount of material which is exposed to each discharge can be changed.

In still a further preferred embodiment of the before described arrangements according to the fourth, fifth or sixth aspect of the invention, the means for feeding process liquid to the process zone and for discharging process liquid from the process zone are designed in such a manner that for changing the feeding and discharging of process liquid into the process zone and from the process zone, the amount, e.g. the volume flow rate, of process liquid fed into the process zone and discharged from the process zone can be changed. This is preferred because it can be done in a simple way and is easy to control. However, it is also envisaged to change the feeding and discharging of process liquid in a different manner, e.g. by changing the physical and/or chemical properties of the process liquid fed into the process zone or e.g. by changing the location, direction or speed at which the process liquid is fed into the process zone.

In still a further preferred embodiment of the before described arrangements according to the fourth, fifth or sixth aspect of the invention, the arrangement furthermore comprises means for conditioning the process liquid discharged from the process zone in such a manner that its degree of turbidity and/or its electrical conductivity is reduced, and furthermore comprises means for completely or partially feeding back the conditioned process liquid into the process zone. By means of this, the amount of process liquid required for running the process can significantly be reduced.

In still a further preferred embodiment of the before described arrangements according to the fourth, fifth or sixth aspect of the invention, the means for feeding process liquid into the process zone and for discharging process liquid from the process zone are adapted to feed and/or discharge process liquid in an uninterrupted manner or in intervals. In the first case the advantage is arrived at that stable operating conditions can be achieved.

In still a further preferred embodiment of the before described arrangements according to the fourth, fifth or sixth aspect of the invention, the at least two electrodes, i.e. the electrodes between which the high voltage discharges are generated, are arranged one above the other and/or beside each other. These configurations have proven to be especially suitable.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 schematically illustrates a first method according to the invention;

FIG. 2 schematically illustrates a second method according to the invention;

FIG. 3 schematically illustrates a third method according to the invention; and

FIG. 4 schematically illustrates a fourth method according to the invention;

### MODES FOR CARRYING OUT THE INVENTION

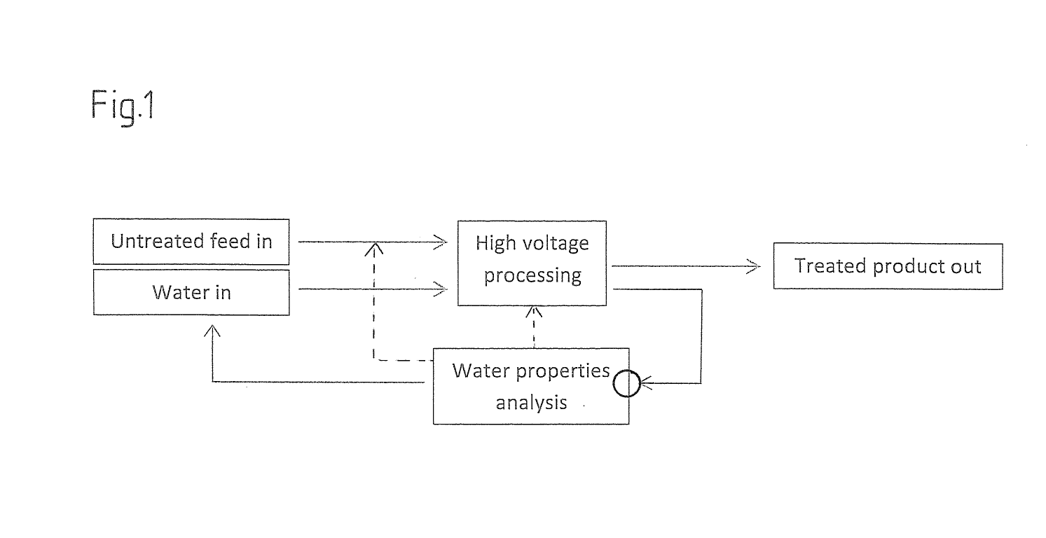

In FIG. 1, a first method according to the invention of fragmenting a rock material by means of high voltage discharges is schematically illustrated. The rock material (“Untreated feed in”) and a process liquid (“Water in”) are continuously fed to a process zone (“High voltage processing”) which is formed between two electrodes arranged at a distance relative to each other. The process zone is flooded with the process liquid and between the two electrodes, high voltage discharges are generated. The rock material which travels through the process zone is treated by the high voltage discharges and thereby is fragmented. The fragmented rock material (“Treated product out”) is continuously discharged from the process zone. The same amount of process liquid which is continuously fed to the process zone is continuously discharged from the process zone. The discharged process liquid is fed to a water analyzing and treatment plant (“Water properties analysis”), where its degree of turbidity is determined. For doing so, the water analyzing and treatment plant comprises an optical system with an optical path that travels through the process liquid between a light emitter and a light receiver and is in position to distinguish different intensities of the light received by the light receiver as different degrees of turbidity. After the determination of its turbidity, the process liquid is filtered and treated inside the water analyzing and treatment plant in order to reduce its turbidity and electrical conductivity. The filtered and treated process liquid is fed back to the process zone. Also inside the water analyzing and treatment plant, the determined degree of turbidity is compared with a reference value. In case the determined turbidity is less than the reference value, the frequency of the high voltage discharges is increased and/or the speed of feeding the rock material through the process zone is decreased. In case the determined turbidity is higher than the reference value, the frequency of the high voltage discharges is decreased and/or the speed of feeding the rock material through the process zone is increased. The determination of the degree of turbidity, the comparing with the reference value and the respective increase or decrease in the frequency of the high voltage discharges and/or in the speed of feeding the rock material is repeated in intervals, e.g. every minute.

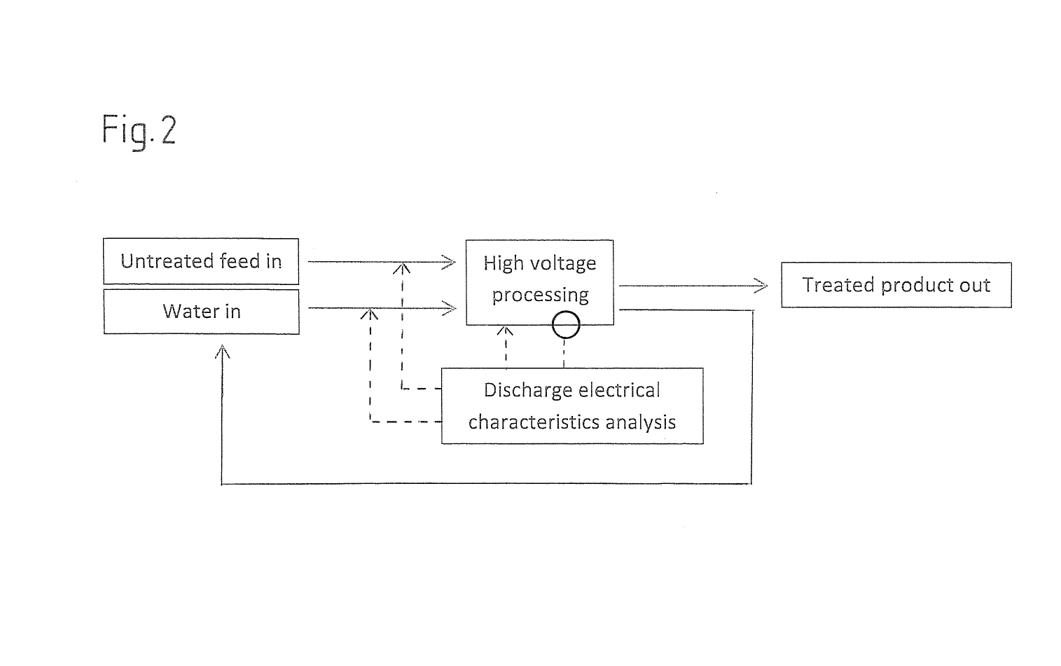

In FIG. 2, a second method according to the invention of fragmenting and weakening copper ore by means of high voltage discharges is schematically illustrated. The copper ore (“Untreated feed in”) and a process liquid (“Water in”) are continuously fed to a process zone (“High voltage processing”) which is formed between two electrodes arranged at a distance relative to each other. The process zone is flooded with the process liquid and between the two electrodes, high voltage discharges are generated. The copper ore which travels through the process zone is treated by the high voltage discharges and thereby is fragmenting and weakened. The fragmented and weakened rock material (“Treated product out”) is continuously discharged from the process zone and fed to a subsequent process for further grinding. The same amount of process liquid which is continuously fed to the process zone is continuously discharged from the process zone. The discharged process liquid is fed back to the process zone. The electrical resistance between the two electrodes before the high voltage discharges occur is determined by means of a measuring and analyzing arrangement (“Discharge electrical characteristics analysis”), which includes computerized measuring equipment that determines electrical parameters of the discharge cycle and derives therefrom the electrical resistance at the point in time before the discharges occur. The electrical resistance between the electrodes before the high voltage discharges occur is computed by the measuring and analyzing arrangement according to the following formula:

$$R = \frac{t}{C} \cdot \frac{1}{ln ( \frac{{U}_{( ds )}}{{U}_{o}} )}$$

wherein R is the electrical resistance between the electrodes before the high voltage discharges occur, U₀ is the maximum voltage between the electrodes, U_{(ds)} is the voltage between the electrodes at the start of the discharge, t is the delay time between the maximum voltage U₀ and the voltage U_{(ds)} at the start of the discharge and C is the known capacitance of the high voltage generator. The term “ln” means natural logarithm. The computed electrical resistance between the electrodes before the high voltage discharges occur is compared inside the measuring and analyzing arrangement with a reference value for this electrical resistance. In case the computed electrical resistance is less than the reference value, the frequency of the high voltage discharges is increased, the voltage of the high voltage discharges is increased, the volume flow rate of process liquid fed into the process zone and discharged from the process zone is reduced and/or the speed of feeding the rock material through the process zone is decreased. In case the computed electrical resistance is higher than the reference value, the frequency of the high voltage discharges is decreased, the voltage of the high voltage discharges is reduced, the volume flow rate of process liquid fed into the process zone and discharged from the process zone is increased and/or the speed of feeding the rock material through the process zone is increased. The determination of the electrical parameters, the computation of the electrical resistance between the electrodes before the high voltage discharges occur from these parameters, the comparing of the computed electrical resistance with the reference value and the respective increase or decrease in the frequency of the high voltage discharges, of the voltage of the high voltage discharges, of the volume flow rate of process liquid fed into the process zone and discharged from the process zone and/or in the speed of feeding the rock material is repeated in intervals, e.g. every minute.

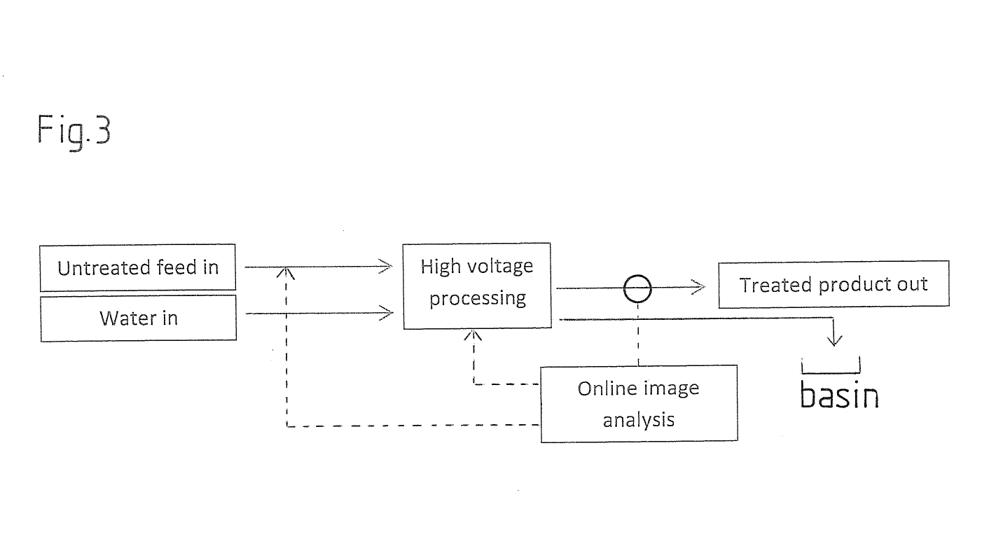

In FIG. 3, a third method according to the invention of fragmenting concrete chunks by means of high voltage discharges is schematically illustrated. The concrete chunks (“Untreated feed in”) and a process liquid (“Water in”) are continuously fed to a process zone (“High voltage processing”) which is formed between two electrodes arranged at a distance relative to each other. The process zone is flooded with the process liquid and between the two electrodes, high voltage discharges are generated. The concrete chunks which travel through the process zone are treated by the high voltage discharges and thereby are fragmented. The fragmented concrete material (“Treated product out”) is continuously discharged from the process zone. The same amount of process liquid which is continuously fed to the process zone is continuously discharged from the process zone. The discharged process liquid is collected in a storage basin for disposal. By means of an online image analyzing unit (“Online image analysis”) comprising a digital camera system with computerized equipment for processing the digital data furnished by the cameras, data representing an image of the fragmented concrete material that is discharged from the process zone are determined and are compared with reference data for the image of fragmented concrete material. In case the comparison shows that the concrete material discharged from the process zone is over-fragmented with regard to the reference, the frequency of the high voltage discharges is reduced, the voltage of the high voltage discharges is reduced and/or the speed of feeding the rock material through the process zone is increased. In case the comparison shows that the concrete material discharged from the process zone is not sufficiently fragmented with regard to the reference, the frequency of the high voltage discharges is increased, the voltage of the high voltage discharges is increased and/or the speed of feeding the rock material through the process zone is decreased. The determination of the data representing an image of the fragmented concrete material, the comparing of these data with the reference data and the respective increase or decrease in the frequency of the high voltage discharges and/or in the speed of feeding the rock material is performed continuously.

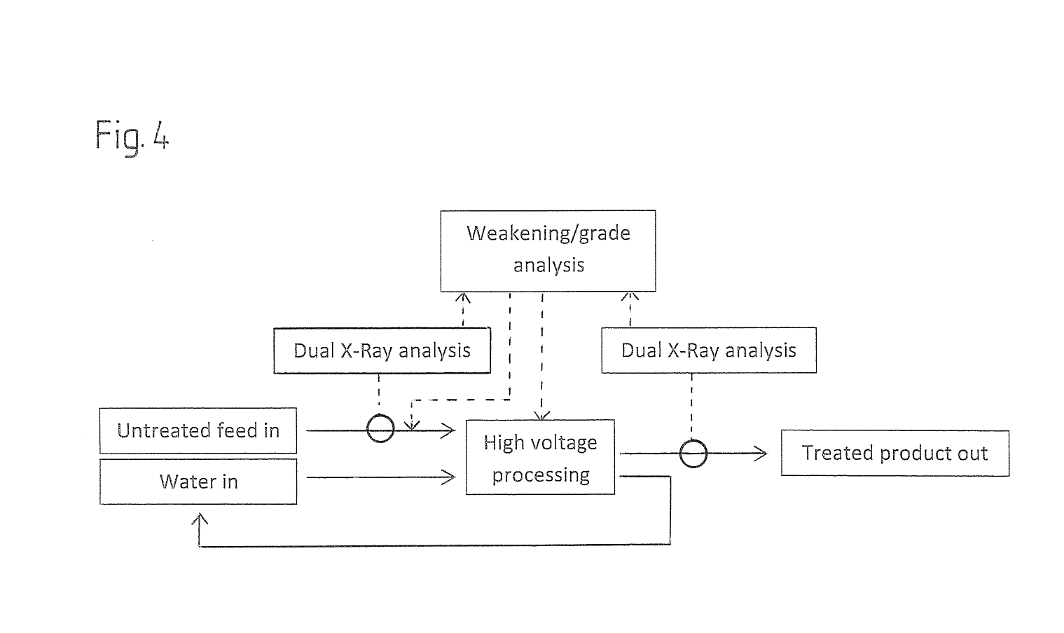

In FIG. 4, a fourth method according to the invention of pre-weakening gemstone containing rock material by means of high voltage discharges is schematically illustrated. The rock material (“Untreated feed in”) and a process liquid (“Water in”) are continuously fed to a process zone (“High voltage processing”) which is formed between two electrodes arranged at a distance relative to each other. The process zone is flooded with the process liquid and between the two electrodes, high voltage discharges are generated. The rock material which travels through the process zone is treated by the high voltage discharges and thereby is weakened. The weakened rock material (“Treated product out”) is continuously discharged from the process zone. The same amount of process liquid which is continuously fed to the process zone is continuously discharged from the process zone. The discharged process liquid is fed back to the process zone. By means of two dual X-ray analysis units (“Dual X-Ray analysis”) comprising digital X-ray camera systems with computerized equipment for processing the digital data furnished by the cameras, data representing an image of the rock material that is fed to the process zone and data representing an image of the weakened rock material that is discharged from the process zone are determined. These data are reported to a weakening analysis unit (“Weakening/grade analysis”), which, by comparing these data provided by the two dual X-ray analysis units, determines the degree of weakening of the rock material that is discharged from the process zone and compares this determined degree of weakening with a reference value for the degree weakening of the material. In case the determined degree of weakening of the rock material is less than the reference value, the frequency of the high voltage discharges is increased, the voltage of the high voltage discharges is increased and/or the speed of feeding the rock material through the process zone is reduced. In case the determined degree of weakening of the rock material is higher than the reference value, the frequency of the high voltage discharges is reduced, the voltage of the high voltage discharges is reduced and/or the speed of feeding the rock material through the process zone is increased. The determination of the data representing the images of the rock material that is fed to the process zone and of the weakened rock material that is discharged from the process zone, the determining of the degree of weakening of the rock material, the comparing of this degree of weakening of the rock material with the reference value and the respective increase or decrease in the frequency of the high voltage discharges and/or in the speed of feeding the rock material is performed in intervals, e.g. every five minutes.

While there are shown and described presently preferred embodiments of the invention, it is to be distinctly understood that the invention is not limited thereto but may be otherwise variously embodied and practiced within the scope of the following claims.

1-54. (canceled)

55. A method of fragmenting and/or weakening a material, in particular rock or ore, by means of high voltage discharges, comprising:
a) providing a process zone between at least two electrodes arranged at a distance relative to each other, which process zone is flooded with a process liquid;
b) feeding through the process zone the material that is to be fragmented and/or weakened;
c) generating high voltage discharges between the at least two electrodes while feeding the material that is to be fragmented and/or weakened through the process zone for fragmenting and/or weakening the material;
d) feeding process liquid into the process zone and discharging process liquid from the process zone while feeding the material that is to be fragmented and/or weakened through the process zone and while generating high voltage discharges between the at least two electrodes;
e) determining a degree of turbidity of the process liquid in the process zone or near the process zone or of the process liquid discharged from the process zone
or determining a difference in the degrees of turbidity of the process liquid fed into the process zone and of the process liquid discharged from the process zone;
f) comparing the determined degree of turbidity with a reference value for the degree of turbidity or the determined difference in the degrees of turbidity with a reference value for the difference in the degrees of turbidity; and
g) changing the generation of high voltage discharges and/or of the feeding of the material through the process zone depending on a detected deviation of the determined degree of turbidity from the reference value for the degree of turbidity or of the determined difference in the degrees of turbidity from the reference value for the difference in the degrees of turbidity in such a manner that, when subsequently the steps e) and f) are repeated, no deviation is detected or the detected deviation is smaller.

56. The method according to claim 55, wherein a pre-determined reference value is used, and wherein, for pre-determining of the reference value, the generating of high voltage discharges between the at least two electrodes and the feeding of the material that is to be fragmented and/or weakened through the process zone is adjusted in such a manner that the fragmented and/or weakened material leaving the process zone has a desired degree of fragmentation or weakening, respectively, and wherein in this operational state the degree of turbidity or the difference in the degrees of turbidity is determined, and subsequently is used as reference value.

57. The method according to claim 55, wherein the determining of the degree of turbidity or of the difference in the degrees of turbidity, the comparing of the determined degree of turbidity or of the determined difference in the degrees of turbidity with a reference value and the possible changing of the generation of high voltage discharges and/or of the feeding of the material through the process zone depending on a detected deviation is performed continuously, in particular in an automated manner, so that in the intended operation the degree of turbidity or the difference in the degrees of turbidity is kept on a level which substantially corresponds to the reference value or falls within a certain scatter around the reference value.

58. The method according to claim 55, wherein the process liquid fed into the process zone has no turbidity or has a substantially constant degree of turbidity.

59. The method according to claim 55, wherein changing the generation of high voltage discharges is accomplished in that the amount of fragmenting or weakening energy which is brought into the process zone by the high voltage discharges is changed, in particular by changing the frequency of the high voltage discharges, the voltage of the high voltage discharges, the form of the pulses which drive the high voltage discharges, the energy stored per pulse in the generator which charges the at least two electrodes, the polarity of the at least two electrodes and/or the electrode gap of the at least two electrodes.

60. The method according to claim 55, wherein changing the feeding of the material through the process zone takes place by changing the residence time of the material in the process zone or by changing the ratio between the amount of material and the amount of process liquid which is present in the process zone.

61. The method according to claim 55, wherein changing the feeding and discharging of process liquid into the process zone and from the process zone is accomplished in that the amount of process liquid that is fed into the process zone and that is discharged from the process zone is changed.

62. The method according to claim 55, wherein the process liquid which is discharged from the process zone is subjected to a conditioning step, in which its degree of turbidity and/or its electrical conductivity is reduced, and then is completely or partly fed back into the process zone.

63. The method according to claim 55, wherein the process liquid fed into the process zone has a substantially constant electrical conductivity.

64. The method according to claim 55, wherein feeding and discharging of process liquid takes place uninterrupted or in intervals.

65. The method according to claim 55, wherein water is used as process liquid.

66. The method according to claim 55, wherein a process zone is provided in which the at least two electrodes are arranged one above the other or beside each other.

67. The method according to claim 55, wherein a noble metal ore or a semiprecious metal ore is used as material to be fragmented and/or weakened, in particular a copper ore, a copper/gold ore or a platinum ore.

68. The method according to claim 55, wherein antecedent to the method a fragmentation and/or weakening of the material that is fragmented and/or weakened takes place, in particular a fragmenting and/or weakening by means of high voltage discharges, in particular by performing the method according to one of the preceding claims.

69. The method according to claim 55, wherein subsequent to the method a fragmentation and/or weakening of the material that has been fragmented and/or weakened takes place, in particular a fragmenting and/or weakening by means of high voltage discharges, in particular by performing the method according to one of the preceding claims, or a mechanical fragmentation.

70. The method according to claim 55, wherein at least one parameter of an upstream process preceding the method and/or of a downstream process succeeding the method is determined and wherein based on this determined parameter the reference value or the reference data is or are changed.

71. The method according to claim 70, wherein the upstream process preceding the method and/or the downstream process succeeding the method is a process performing the method according to one of the preceding claims in which the material that is fed through the process zone and/or the material that is discharged from the process zone is fragmented and/or weakened.

72. The method according to claim 70, wherein the at least one parameter is a parameter of an upstream process that is correlated to the properties of the material that is leaving the upstream process for being fed to the process zone in order to be fragmented and/or weakened, in particular correlated to the type, amount, hardness and/or particle size of the material leaving the upstream process.

73. The method according to claim 72, wherein the at least one parameter is the power consumption of an apparatus for treating the material in the upstream process, in particular of a crusher or a mill, the particle size of the material leaving the upstream process, the consumption of chemical additives or reagents used in the upstream process, the concentration of certain substances in a process fluid of the upstream process, and/or the amount of material leaving the upstream process.

74. The method according to claim 70, wherein the at least one parameter is a parameter of a downstream process that is correlated to the properties of the fragmented and/or weakened material that is discharged from the process zone and is received by the downstream process for further treatment, in particular correlated to the type, amount, grindability, hardness and/or particle size of the material.

75. The method according to claim 74, wherein the at least one parameter is the power consumption of an apparatus for treating the material in the downstream process, in particular of a mill or a crusher, the pressure of a ball mill cyclone used in the downstream process, the particle size of the material entering the downstream process, the amount of material entering the downstream stream process, the consumption of chemical additives or reagents used in the downstream process, the concentration of certain substances in a process fluid of the downstream process, a tailing grade or a recovery factor achieved in the downstream process and/or the amount of material leaving the downstream process.

76. A method of fragmenting and/or weakening a material, in particular rock or ore, by means of high voltage discharges, comprising the steps:
a) providing a process zone between at least two electrodes arranged at a distance relative to each other, which process zone is flooded with a process liquid;
b) feeding through the process zone the material that is to be fragmented and/or weakened;
c) generating high voltage discharges between the at least two electrodes while feeding the material that is to be fragmented and/or weakened through the process zone for fragmenting and/or weakening the material;
d) feeding process liquid into the process zone and discharging process liquid from the process zone while feeding the material that is to be fragmented and/or weakened through the process zone and while generating high voltage discharges between the at least two electrodes;
e) determining the electrical resistance between at least two of the at least two electrodes, between at least one of the at least two electrodes and at least one auxiliary electrode or between at least two auxiliary electrodes before the high voltage discharges occur;
f) comparing the determined electrical resistance with a reference value for the electrical resistance; and
g) changing the feeding of material through the process zone, the generating of high voltage discharges between the at least two electrodes, the distance between the at least two electrodes and/or the feeding and discharging of process liquid into the process zone and from the process zone depending on a detected deviation of the determined resistance from the reference value in such a manner that, when subsequently the steps e) and f) are repeated, no deviation is detected or the detected deviation is smaller.

77. The method according to claim 76, wherein for determining the electrical resistance before the high voltage discharges occur, the maximum voltage between the electrodes, the voltage between the electrodes at the start of the discharge and the delay time between the maximum voltage and the voltage at the start of the discharge are determined and, with the known capacitance of the high voltage generator charging the electrodes, the electrical resistance between the electrodes before the high voltage discharges occur is computed according to or with involvement of the following formula:
$$R = \frac{t}{C} \cdot \frac{1}{ln ( \frac{{U}_{( ds )}}{{U}_{o}} )}$$
wherein R is the electrical resistance between the electrodes before the high voltage discharges occur, U0 is the maximum voltage between the electrodes, U(ds) is the voltage between the electrodes at the start of the discharge, t is the delay time between the maximum voltage U0 and the voltage U(ds) at the start of the discharge and C is the known capacitance of the high voltage generator.

78. The method according to claim 76, wherein a pre-determined reference value is used and wherein, for pre-determining of the reference value, the generating of high voltage discharges between the at least two electrodes, the feeding of the material that is to be fragmented and/or weakened through the process zone, the distance between the electrodes and the feeding and discharging of process liquid is adjusted in such a manner that the fragmented and/or weakened material leaving the process zone has a desired degree of fragmentation or weakening, respectively, and wherein, in this operational state, the resistance between the electrodes before the high voltage discharges occur is determined, and subsequently is used as reference value.

79. The method according to claim 76, wherein the determining of the electrical resistance between the electrodes, the comparing of the determined electrical resistance with a reference value and the possible changing of the feeding of material through the process zone, of the generating of high voltage discharges between the electrodes, of the distance between the at least two electrodes and/or of the feeding and discharging of process liquid into the process zone and from the process zone depending on a detected deviation of the determined resistance from the reference value is performed continuously, in particular in an automated manner, so that, in the intended operation, the electrical resistance between the electrodes before the high voltage discharges occur is kept on a level which substantially corresponds to the reference value or falls within a certain scatter around the reference value.

80. The method according to claim 76, wherein changing the generation of high voltage discharges is accomplished in that the amount of fragmenting or weakening energy which is brought into the process zone by the high voltage discharges is changed, in particular by changing the frequency of the high voltage discharges, the voltage of the high voltage discharges, the form of the pulses which drive the high voltage discharges, the energy stored per pulse in the generator which charges the at least two electrodes, the polarity of the at least two electrodes and/or the electrode gap of the at least two electrodes.

81. The method according to claim 76, wherein changing the feeding of the material through the process zone takes place by changing the residence time of the material in the process zone or by changing the ratio between the amount of material and the amount of process liquid which is present in the process zone.

82. The method according to claim 76, wherein changing the feeding and discharging of process liquid into the process zone and from the process zone is accomplished in that the amount of process liquid that is fed into the process zone and that is discharged from the process zone is changed.

83. The method according to claim 76, wherein the process liquid which is discharged from the process zone is subjected to a conditioning step, in which its degree of turbidity and/or its electrical conductivity is reduced, and then is completely or partly fed back into the process zone.

84. The method according to claim 76, wherein the process liquid fed into the process zone has a substantially constant electrical conductivity.

85. The method according to claim 76, wherein feeding and discharging of process liquid takes place uninterrupted or in intervals.

86. The method according to claim 76, wherein water is used as process liquid.

87. The method according to claim 76, wherein a process zone is provided in which the at least two electrodes are arranged one above the other or beside each other.

88. The method according to claim 76, wherein a noble metal ore or a semiprecious metal ore is used as material to be fragmented and/or weakened, in particular a copper ore, a copper/gold ore or a platinum ore.

89. The method according to claim 76, wherein antecedent to the method a fragmentation and/or weakening of the material that is fragmented and/or weakened takes place, in particular a fragmenting and/or weakening by means of high voltage discharges, in particular by performing the method according to one of the preceding claims.

90. The method according to claim 76, wherein subsequent to the method a fragmentation and/or weakening of the material that has been fragmented and/or weakened takes place, in particular a fragmenting and/or weakening by means of high voltage discharges, in particular by performing the method according to one of the preceding claims, or a mechanical fragmentation.

91. The method according to claim 76, wherein at least one parameter of an upstream process preceding the method and/or of a downstream process succeeding the method is determined and wherein based on this determined parameter the reference value or the reference data is or are changed.

92. The method according to claim 91, wherein the upstream process preceding the method and/or the downstream process succeeding the method is a process performing the method according to one of the preceding claims in which the material that is fed through the process zone and/or the material that is discharged from the process zone is fragmented and/or weakened.

93. The method according to claim 91, wherein the at least one parameter is a parameter of an upstream process that is correlated to the properties of the material that is leaving the upstream process for being fed to the process zone in order to be fragmented and/or weakened, in particular correlated to the type, amount, hardness and/or particle size of the material leaving the upstream process.

94. The method according to claim 93, wherein the at least one parameter is the power consumption of an apparatus for treating the material in the upstream process, in particular of a crusher or a mill, the particle size of the material leaving the upstream process, the consumption of chemical additives or reagents used in the upstream process, the concentration of certain substances in a process fluid of the upstream process, and/or the amount of material leaving the upstream process.

95. The method according to claim 91, wherein the at least one parameter is a parameter of a downstream process that is correlated to the properties of the fragmented and/or weakened material that is discharged from the process zone and is received by the downstream process for further treatment, in particular correlated to the type, amount, grindability, hardness and/or particle size of the material.

96. The method according to claim 95, wherein the at least one parameter is the power consumption of an apparatus for treating the material in the downstream process, in particular of a mill or a crusher, the pressure of a ball mill cyclone used in the downstream process, the particle size of the material entering the downstream process, the amount of material entering the downstream stream process, the consumption of chemical additives or reagents used in the downstream process, the concentration of certain substances in a process fluid of the downstream process, a tailing grade or a recovery factor achieved in the downstream process and/or the amount of material leaving the downstream process.

97. A method of fragmenting and/or weakening a material, in particular rock or ore, by means of high voltage discharges, comprising:
a) providing a process zone between at least two electrodes arranged at a distance relative to each other, which process zone is flooded with a process liquid;
b) feeding through the process zone the material that is to be fragmented and/or weakened;
c) generating high voltage discharges between the at least two electrodes while feeding the material that is to be fragmented and/or weakened through the process zone for fragmenting and/or weakening the material;
d) determining data representing an image of the fragmented and/or weakened material that is discharged from the process zone
or
determining data representing an image of the material that is fed to the process zone, determining data representing an image of the fragmented and/or weakened material that is discharged from the process zone and determining the degree of fragmentation and/or weakening of the material by comparing the determined data representing the image of the material that is fed to the process zone with the determined data representing the image of the fragmented and/or weakened material that is discharged from the process zone;
e) comparing the data representing the image of the fragmented and/or weakened material with reference data for the image of fragmented and/or weakened material
or
comparing the determined degree of fragmentation and/or weakening of the material with a reference value for the degree of fragmentation and/or weakening; and
f) changing the generation of high voltage discharges and/or of the feeding of the material through the process zone depending on a detected deviation of the determined data representing the image from the reference data or depending on a detected deviation of the determined degree of fragmentation and/or weakening of the material from the reference value in such a manner that, when subsequently the steps d) and e) are repeated, no deviation is detected or the detected deviation is smaller.

98. The method according to claim 97, further comprising the step:
g) feeding process liquid into the process zone and discharging process liquid from the process zone while feeding the material that is to be fragmented and/or weakened through the process zone and while generating high voltage discharges between the at least two electrodes.

99. The method according to claim 97, wherein the data representing the image are determined by using a digital camera, in particular by using a digital X-Ray camera.

100. The method according to claim 97, wherein pre-determined reference data are used and wherein, for pre-determining the reference data, the generating of high voltage discharges between the at least two electrodes and the feeding of the material that is to be fragmented and/or weakened through the process zone is adjusted in such a manner that the fragmented and/or weakened material leaving the process zone has a desired degree of fragmentation or weakening, respectively, and wherein, in this operational state, data representing an image of this material are determined, and subsequently are used as reference data.

101. The method according to claim 97, wherein the determining of the data representing an image of the fragmented and/or weakened material, the comparing of the determined data representing the image with reference data and the possible changing of the generation of high voltage discharges and/or of the feeding of the material through the process zone depending on a detected deviation is performed continuously, in particular in an automated manner, so that in the intended operation the determined data representing the image substantially corresponds to the reference data or deviate therefrom within a certain scatter.

102. The method according to claim 97, wherein a pre-determined reference value is used and wherein, for pre-determining the reference value, the generating of high voltage discharges between the at least two electrodes and the feeding of the material that is to be fragmented and/or weakened through the process zone is adjusted in such a manner that the fragmented and/or weakened material leaving the process zone has a desired degree of fragmentation or weakening, respectively,
and wherein, in this operational state, data representing an image of the material that is fed to the process zone and data representing an image of the fragmented and/or weakened material that is discharged from the process zone are determined, a degree of fragmentation and/or weakening of the material is determined by comparing the determined data representing the image of the material that is fed to the process zone with the determined data representing the image of the fragmented and/or weakened material that is discharged from the process zone and subsequently, this determined degree of fragmentation and/or weakening of the material is used as reference value.

103. The method according to claim 97, wherein the determining of the data representing the images of the material fed to and discharged from the process zone, the determining of the degree of fragmentation and/or weakening of the material, the comparing of the determined degree of fragmentation and/or weakening with the reference value and the possible changing of the generation of high voltage discharges and/or of the feeding of the material through the process zone depending on a detected deviation is performed continuously, in particular in an automated manner, so that in the intended operation the determined degree of fragmentation and/or weakening substantially corresponds to the reference value or deviates therefrom within a certain scatter.

104. The method according to claim 97, wherein changing the generation of high voltage discharges is accomplished in that the amount of fragmenting or weakening energy which is brought into the process zone by the high voltage discharges is changed, in particular by changing the frequency of the high voltage discharges, the voltage of the high voltage discharges, the form of the pulses which drive the high voltage discharges, the energy stored per pulse in the generator which charges the at least two electrodes, the polarity of the at least two electrodes and/or the electrode gap of the at least two electrodes.

105. The method according to claim 97, wherein changing the feeding of the material through the process zone takes place by changing the residence time of the material in the process zone or by changing the ratio between the amount of material and the amount of process liquid which is present in the process zone.

106. The method according to claim 97, wherein changing the feeding and discharging of process liquid into the process zone and from the process zone is accomplished in that the amount of process liquid that is fed into the process zone and that is discharged from the process zone is changed.

107. The method according to claim 97, wherein the process liquid which is discharged from the process zone is subjected to a conditioning step, in which its degree of turbidity and/or its electrical conductivity is reduced, and then is completely or partly fed back into the process zone.

108. The method according to claim 97, wherein the process liquid fed into the process zone has a substantially constant electrical conductivity.

109. The method according to claim 97, wherein feeding and discharging of process liquid takes place uninterrupted or in intervals.

110. The method according to claim 97, wherein water is used as process liquid.

111. The method according to claim 97, wherein a process zone is provided in which the at least two electrodes are arranged one above the other or beside each other.

112. The method according to claim 97, wherein a noble metal ore or a semiprecious metal ore is used as material to be fragmented and/or weakened, in particular a copper ore, a copper/gold ore or a platinum ore.

113. The method according to claim 97, wherein antecedent to the method a fragmentation and/or weakening of the material that is fragmented and/or weakened takes place, in particular a fragmenting and/or weakening by means of high voltage discharges, in particular by performing the method according to one of the preceding claims.

114. The method according to claim 97, wherein subsequent to the method a fragmentation and/or weakening of the material that has been fragmented and/or weakened takes place, in particular a fragmenting and/or weakening by means of high voltage discharges, in particular by performing the method according to one of the preceding claims, or a mechanical fragmentation.

115. The method according to claim 97, wherein at least one parameter of an upstream process preceding the method and/or of a downstream process succeeding the method is determined and wherein based on this determined parameter the reference value or the reference data is or are changed.

116. The method according to claim 115, wherein the upstream process preceding the method and/or the downstream process succeeding the method is a process performing the method according to one of the preceding claims in which the material that is fed through the process zone and/or the material that is discharged from the process zone is fragmented and/or weakened.

117. The method according to claim 115, wherein the at least one parameter is a parameter of an upstream process that is correlated to the properties of the material that is leaving the upstream process for being fed to the process zone in order to be fragmented and/or weakened, in particular correlated to the type, amount, hardness and/or particle size of the material leaving the upstream process.

118. The method according to claim 117, wherein the at least one parameter is the power consumption of an apparatus for treating the material in the upstream process, in particular of a crusher or a mill, the particle size of the material leaving the upstream process, the consumption of chemical additives or reagents used in the upstream process, the concentration of certain substances in a process fluid of the upstream process, and/or the amount of material leaving the upstream process.

119. The method according to claim 115, wherein the at least one parameter is a parameter of a downstream process that is correlated to the properties of the fragmented and/or weakened material that is discharged from the process zone and is received by the downstream process for further treatment, in particular correlated to the type, amount, grindability, hardness and/or particle size of the material.

120. The method according to claim 119, wherein the at least one parameter is the power consumption of an apparatus for treating the material in the downstream process, in particular of a mill or a crusher, the pressure of a ball mill cyclone used in the downstream process, the particle size of the material entering the downstream process, the amount of material entering the downstream stream process, the consumption of chemical additives or reagents used in the downstream process, the concentration of certain substances in a process fluid of the downstream process, a tailing grade or a recovery factor achieved in the downstream process and/or the amount of material leaving the downstream process.

121. An arrangement for conducting the method according to claim 55, the arrangement comprising:
a) a process zone between at least two electrodes which are arranged at a distance relative to each other, which process zone in the intended operation is flooded with a process liquid;
b) means for feeding in the intended operation the material that is to be fragmented and/or weakened through the process zone;
c) means for generating high voltage discharges between the at least two electrodes in the intended operation while feeding the material that is to be fragmented and/or weakened through the process zone for fragmenting and/or weakening the material;
d) means for feeding process liquid into the process zone and for discharging process liquid from the process zone in the intended operation while feeding the material that is to be fragmented and/or weakened through the process zone and while generating high voltage discharges between the at least two electrodes; and
e) means for determining a degree of turbidity of the process liquid in the process zone or near the process zone or of the liquid discharged from the process zone or for determining a difference in the degrees of turbidity of the process liquid fed into the process zone and of the process liquid discharged from the process zone,
wherein the means for generating high voltage discharges between the at least two electrodes and/or the means for feeding the material that is to be fragmented and/or weakened through the process zone are designed in such a manner that the generating of the high voltage discharges and/or the feeding of the material through the process zone can be changed.

122. The arrangement according to claim 121, wherein the arrangement comprises a control unit by means of which the determined degree of turbidity can be compared with a reference value for the degree of turbidity or the determined difference in the degrees of turbidity can be compared with a reference value for the difference in the degrees of turbidity and, depending on a detected deviation of the determined degree of turbidity or of the determined difference in the degrees of turbidity from the reference value, the means for generating high voltage discharges between the at least two electrodes and/or the means for feeding the material that is to be fragmented and/or weakened through the process zone can be controlled in such a manner that there is a change in the generating of high voltage discharges between the at least two electrodes and/or in the feeding of the material through the process such that, when subsequently the degree of turbidity or the difference in the degrees of turbidity is determined and compared with the reference value, no deviation is detected or the detected deviation is smaller.

123. The arrangement according to claim 122, wherein the control unit is designed in such a manner that the determining of the degree of turbidity or of the difference in the degrees of turbidity, the comparing of the determined degree of turbidity or of the determined difference in the degrees of turbidity with the reference value and the possible changing in the generating of the high voltage discharges and/or in the feeding of the material through the process zone depending on a detected deviation takes placed continuously, in particular in an automated manner, so that in the intended operation the degree of turbidity or the difference in the degrees of turbidity is kept on a level which substantially corresponds to the reference value or falls within a certain scatter around the reference value.

124. The arrangement according to claim 122, wherein the control unit is adapted for comparing the determined degree of turbidity or the determined difference in the degrees of turbidity with a reference value which has been pre-determined by it, in particular in an automated manner, in that, when the generating of high voltage discharges between the at least two electrodes and the feeding of the material that is to be fragmented and/or weakened through the process zone is adjusted in such a manner that the fragmented and/or weakened material leaving the process zone has a desired degree of fragmentation or weakening, respectively, in this operational state the degree of turbidity or the difference in the degrees of turbidity is determined, and subsequently is used as reference value for the degree of turbidity or as reference value for the difference in the degrees of turbidity.

125. The arrangement according to claim 121, wherein the means for generating the high voltage discharges between the at least two electrodes are designed in such a manner that for changing the generation of high voltage discharges, the amount of fragmenting or weakening energy which is brought into the process zone by the high voltage discharges can be changed, in particular by changing the frequency of the high voltage discharges, the voltage of the high voltage discharges, the form of the pulses which drive the high voltage discharges, the energy stored per pulse in the generator which charges the at least two electrodes, the polarity of the at least two electrodes and/or the electrode gap of the at least two electrodes.

126. The arrangement according to claim 121, wherein the means for feeding the material that is to be fragmented and/or weakened through the process zone are designed in such a manner that for changing the feeding of the material through the process zone the residence time of the material in the process zone can be changed or the ratio between the amount of material and the amount of process liquid which is present in the process zone can be changed.

127. The arrangement according to claim 121, wherein the means for feeding process liquid to the process zone and for discharging process liquid from the process zone are designed in such a manner that for changing the feeding and discharging of process liquid into the process zone and from the process zone the amount of process liquid fed into the process zone and discharged from the process zone can be changed.

128. The arrangement according to claim 121, furthermore comprising means for conditioning the process liquid discharged from the process zone in such a manner that its degree of turbidity and/or its electrical conductivity is reduced, and furthermore comprising means for completely or partially feeding back the conditioned process liquid into the process zone.

129. The arrangement according to claim 121, wherein the means for feeding process liquid into the process zone and for discharging process liquid from the process zone are adapted to feed and/or discharge process liquid in an uninterrupted manner or in intervals.

130. The arrangement according to claim 121, wherein the at least two electrodes are arranged one above the other or beside each other.

131. An arrangement for conducting the method of claim 76, comprising:
a) a process zone between at least two electrodes which are arranged at a distance relative to each other, which process zone in the intended operation is flooded with a process liquid;
b) means for feeding in the intended operation the material that is to be fragmented and/or weakened through the process zone;
c) means for generating high voltage discharges between the at least two electrodes in the intended operation while feeding the material that is to be fragmented and/or weakened through the process zone for fragmenting and/or weakening the material;
d) means for feeding process liquid into the process zone and for discharging process liquid from the process zone in the intended operation while feeding the material that is to be fragmented and/or weakened through the process zone and while generating high voltage discharges between the at least two electrodes; and
e) means for determining the electrical resistance between at least two of the at least two electrodes, between at least one of the at least two electrodes and at least one auxiliary electrode or between at least two auxiliary electrodes before the high voltage discharges occur,
wherein the means for feeding the material through the process zone, the means for generating high voltage discharges between the at least two electrodes and/or the means for feeding and discharging process liquid into the process zone and from the process zone are designed in such a manner that the feeding of material through the process zone, the generating of high voltage discharges between the at least two electrodes and/or the feeding and discharging of process liquid into the process zone and from the process zone can be changed.

132. The arrangement according to claim 131, further comprising means for adjusting the distance between the at least two electrodes.

133. The arrangement according to claim 131, wherein the arrangement comprises a control unit by means of which the determined electrical resistance can be compared with a reference value for the electrical resistance and, depending on a detected deviation of the determined electrical resistance from the reference value, the means for feeding material through the process zone, the means for generating high voltage discharges between the at least two electrodes, the means for feeding and discharging process liquid into the process zone and from the process zone and/or the means for adjusting the distance between the at least two electrodes can be controlled in such a manner that there is a change in the feeding of material through the process zone, in the generating of high voltage discharges between the at least two electrodes, in the feeding and discharging of process liquid into the process zone and from the process zone and/or in the distance between the at least two electrodes such that, when subsequently the electrical resistance between the electrodes is determined and compared with the reference value, no deviation is detected or the detected deviation is smaller.

134. The arrangement according to claim 133, wherein the control unit is designed in such a manner that the determining of the electrical resistance, the comparing of the determined electrical resistance with a reference value and the possible changing of the feeding of material through the process zone, of the generating of high voltage discharges between the at least two electrodes, of the feeding and discharging of process liquid into the process zone and from the process zone and/or of the distance between the at least two electrodes depending on a detected deviation takes placed continuously, in particular in an automated manner, so that in the intended operation the electrical resistance between the electrodes before the high voltage discharges occur is kept on a level which substantially corresponds to the reference value or falls within a certain scatter around the reference value.

135. The arrangement according claim 133, wherein the control unit is adapted for comparing the determined electrical resistance with a reference value, which has been pre-determined by it, in particular in an automated manner, in that, when the generating of high voltage discharges between the at least two electrodes, the feeding of the material that is to be fragmented and/or weakened through the process zone and the feeding and discharging of process liquid is adjusted in such a manner that the fragmented and/or weakened material leaving the process zone has a desired degree of fragmentation or weakening, respectively, in this operational state the electrical resistance between the electrodes before the high voltage discharges occur is determined, and subsequently is used as reference value for the electrical resistance.

136. The arrangement according to claim 131, wherein the means for generating the high voltage discharges between the at least two electrodes are designed in such a manner that for changing the generation of high voltage discharges, the amount of fragmenting or weakening energy which is brought into the process zone by the high voltage discharges can be changed, in particular by changing the frequency of the high voltage discharges, the voltage of the high voltage discharges, the form of the pulses which drive the high voltage discharges, the energy stored per pulse in the generator which charges the at least two electrodes, the polarity of the at least two electrodes and/or the electrode gap of the at least two electrodes.

137. The arrangement according to claim 131, wherein the means for feeding the material that is to be fragmented and/or weakened through the process zone are designed in such a manner that for changing the feeding of the material through the process zone the residence time of the material in the process zone can be changed or the ratio between the amount of material and the amount of process liquid which is present in the process zone can be changed.

138. The arrangement according to claim 131, wherein the means for feeding process liquid to the process zone and for discharging process liquid from the process zone are designed in such a manner that for changing the feeding and discharging of process liquid into the process zone and from the process zone the amount of process liquid fed into the process zone and discharged from the process zone can be changed.

139. The arrangement according to claim 131, furthermore comprising means for conditioning the process liquid discharged from the process zone in such a manner that its degree of turbidity and/or its electrical conductivity is reduced, and furthermore comprising means for completely or partially feeding back the conditioned process liquid into the process zone.

140. The arrangement according to claim 131, wherein the means for feeding process liquid into the process zone and for discharging process liquid from the process zone are adapted to feed and/or discharge process liquid in an uninterrupted manner or in intervals.

141. The arrangement according to claim 131, wherein the at least two electrodes are arranged one above the other or beside each other.

142. An arrangement for conducting the method according to claim 97, comprising:
a) a process zone between at least two electrodes which are arranged at a distance relative to each other, which process zone in the intended operation is flooded with a process liquid;
b) means for feeding in the intended operation the material that is to be fragmented and/or weakened through the process zone;
c) means for generating high voltage discharges between the at least two electrodes in the intended operation while feeding the material that is to be fragmented and/or weakened through the process zone for fragmenting and/or weakening the material; and
e) means for determining data representing an image of the fragmented and/or weakened material that is discharged from the process zone
or
means for determining data representing an image of the material that is fed to the process zone, for determining data representing an image of the fragmented and/or weakened material that is discharged from the process zone and for determining the degree of fragmentation and/or weakening of the material by comparing the determined data representing the image of the material that is fed to the process zone with the determined data representing the image of the fragmented and/or weakened material that is discharged from the process zone;
wherein the means for generating high voltage discharges between the at least two electrodes and/or the means for feeding the material that is to be fragmented and/or weakened through the process zone are designed in such a manner that the generating of the high voltage discharges and/or the feeding of the material through the process zone can be changed.

143. The arrangement according to claim 142, further comprising means for feeding process liquid into the process zone and for discharging process liquid from the process zone in the intended operation while feeding the material that is to be fragmented and/or weakened through the process zone and while generating high voltage discharges between the at least two electrodes.

144. The arrangement according to claim 142, wherein the arrangement comprises a control unit by means of which the determined data representing the image of the fragmented and/or weakened material can be compared with reference data for the image of the fragmented and/or weakened material or by means of which the determined degree of fragmentation and/or weakening of the material can be compared with a reference value for the degree of fragmentation and/or weakening
and, depending on a detected deviation of the determined data representing the image from the reference data or depending on a detected deviation of the determined degree of fragmentation and/or weakening of the material from the reference value,
the means for generating high voltage discharges between the at least two electrodes and/or the means for feeding the material that is to be fragmented and/or weakened through the process zone can be controlled in such a manner that there is a change in the generating of high voltage discharges between the at least two electrodes and/or in the feeding of the material through the process zone such that, when subsequently data representing an image of the fragmented and/or weakened material are determined and are compared with the reference data, or, when subsequently the degree of fragmentation and/or weakening of the material is determined and is compared with the reference value for the degree of fragmentation and/or weakening, no deviation is detected or the detected deviation is smaller.

145. The arrangement according to claim 144, wherein the control unit is designed in such a manner that the determining of the data representing the image of the material, the comparing of the determined data representing the image with reference data and the possible changing in the generating of the high voltage discharges and/or in the feeding of the material through the process zone depending on a detected deviation takes place continuously, in particular in an automated manner, so that in the intended operation the data representing the image substantially correspond to the reference data or deviate therefrom within a certain scatter.

146. The arrangement according to claim 144, wherein the control unit is adapted for comparing the determined data representing the image with reference data which have been pre-determined by it, in particular in an automated manner, in that, when the generating of high voltage discharges between the at least two electrodes and the feeding of the material that is to be fragmented and/or weakened through the process zone is adjusted in such a manner that the fragmented and/or weakened material leaving the process zone has a desired degree of fragmentation or weakening, respectively, in this operational state the data representing the image of the fragmented and/or weakened material are determined, and subsequently are used as reference data.

147. The arrangement according to claim 144, wherein the control unit is designed in such a manner that the determining of the data representing the images of the material, the determining of the degree of fragmentation and/or weakening of the material and the comparing of the determined degree of fragmentation and/or weakening of the material with the reference value and the possible changing in the generating of the high voltage discharges and/or in the feeding of the material through the process zone depending on a detected deviation takes place continuously, in particular in an automated manner, so that in the intended operation the degree of fragmentation and/or weakening of the material corresponds to the reference value or deviates therefrom within a certain scatter.

148. The arrangement according to claim 144, wherein the control unit is adapted for comparing the determined degree of fragmentation and/or weakening of the material with a reference value for the degree of fragmentation and/or weakening which has been pre-determined by it, in particular in an automated manner, in that, when the generating of high voltage discharges between the at least two electrodes and the feeding of the material that is to be fragmented and/or weakened through the process zone is adjusted in such a manner that the fragmented and/or weakened material leaving the process zone has a desired degree of fragmentation or weakening, respectively, in this operational state the data representing the images of the material are determined and therefrom the degree of fragmentation and/or weakening of the material is determined, which degree of fragmentation and/or weakening of the material subsequently is used as reference value for the degree of fragmentation and/or weakening.

149. The arrangement according to claim 142, wherein the means for generating the high voltage discharges between the at least two electrodes are designed in such a manner that for changing the generation of high voltage discharges, the amount of fragmenting or weakening energy which is brought into the process zone by the high voltage discharges can be changed, in particular by changing the frequency of the high voltage discharges, the voltage of the high voltage discharges, the form of the pulses which drive the high voltage discharges, the energy stored per pulse in the generator which charges the at least two electrodes, the polarity of the at least two electrodes and/or the electrode gap of the at least two electrodes.

150. The arrangement according to claim 142, wherein the means for feeding the material that is to be fragmented and/or weakened through the process zone are designed in such a manner that for changing the feeding of the material through the process zone the residence time of the material in the process zone can be changed or the ratio between the amount of material and the amount of process liquid which is present in the process zone can be changed.

151. The arrangement according to claim 142, wherein the means for feeding process liquid to the process zone and for discharging process liquid from the process zone are designed in such a manner that for changing the feeding and discharging of process liquid into the process zone and from the process zone the amount of process liquid fed into the process zone and discharged from the process zone can be changed.

152. The arrangement according to claim 142, furthermore comprising means for conditioning the process liquid discharged from the process zone in such a manner that its degree of turbidity and/or its electrical conductivity is reduced, and furthermore comprising means for completely or partially feeding back the conditioned process liquid into the process zone.

153. The arrangement according to claim 142, wherein the means for feeding process liquid into the process zone and for discharging process liquid from the process zone are adapted to feed and/or discharge process liquid in an uninterrupted manner or in intervals.

154. The arrangement according to claim 142, wherein the at least two electrodes are arranged one above the other or beside each other.
